(19) United States
(12) Patent Application Publication
(10) Pub. No.: US 2019/0034898 A1
(43) Pub. Date: Jan. 31, 2019

(54) METHODS AND SYSTEMS FOR HANDLING SALES RECEIPTS

(71) Applicant: ReceetMe, Ltd., Hashmonaim (IL)

(72) Inventors: Helene BERKOWITZ, Hashmonaim (IL); Sumit GUPTA, Waterloo (CA)

(21) Appl. No.: 16/046,654

(22) Filed: Jul. 26, 2018

Related U.S. Application Data
(60) Provisional application No. 62/537,362, filed on Jul. 26, 2017.

(51) Int. Cl. G06Q 20/20; G06Q 20/04

(52) U.S. Cl. CPC G06Q 20/202; G06Q 20/0453

(57) ABSTRACT

The present application discloses a method of organizing digital receipts collected from different retailers, different transactions, and at different locations or times. In one embodiment, a mobile application aggregates digital receipts from different retail purchases, including cash purchases, stores and organizes such receipts according to time, location, retailer, etc. for easy retrieval.

### CROSS-REFERENCE TO RELATED APPLICATIONS

This application claims priority to U.S. Provisional Application No. 62/537,362 filed on Jul. 26, 2017, and titled Methods and Apparatus for Collecting, Storing, and Organizing Sales Receipts and Related Data, the entire content of which is incorporated herein in its entirety.

### FIELD OF THE INVENTION

The present disclosure relates generally to handling sales receipts, and more specifically to aggregating and organizing sales receipts from different retail sales of goods and merchandise.

### BACKGROUND OF THE INVENTION

Receipts are proof of transaction that records what items were purchased at what price when and where. As proof of transaction, receipts are required in many occasions. For example, a receipt is often required to return an unwanted item to the store. A receipt is also required by an employer before the expense can be reimbursed to the employee. Receipts are also needed for purpose of filing tax return, expense tracking, etc. For various reasons, people save receipts and keep them in storage, for example, shoe boxes.

Even in this digital age, paper receipts are still what people keep as records. Some stores have begun to email receipts to customers, when, at the point of sale, the customer selects to have the receipt emailed to them. Emailed receipts are not the best means for record-keeping. In many cases, email inboxes are already crowded, making locating any relevant record both time-consuming and frustrating. Some devices can scan or take a picture of paper receipts but those devices still require extra steps from consumers. Also, those devices still require paper receipts. Some retail companies offer mobile applications for receiving and collecting their own receipts. These mobile applications work exclusively at their stores, and most often include only purchases made by credit/debit cards. Purchases made by checks, cash, and gift cards are excluded. Some banks offer mobile applications to receive and collect receipts of purchases made with the banks' own credit and debit cards.

There is a lack of convenient solution that aggregates receipts of sales, e.g., from different retail stores and of different transaction types, into one simple, organized, and easily searchable location.

### SUMMARY OF THE INVENTION

Accordingly, it is an objective of the present disclosure to teach a method of aggregating and organizing digital receipts. In some embodiments, transaction information of a purchase made at a retailer store is collected. The transaction information is stored as digital receipt. A plurality of digital receipts is organized according to date, time, retailer, and/or amount. When a user needs to find a particular receipt, the system searches among the stored digital receipts and retrieves the correct digital receipt. The retrieved digital receipt is then displayed in response to a user query. In some embodiments, transaction information of two or more purchases completed at different retail stores is collected. In some embodiments, some purchases are cash transaction.

The present disclosure also teaches an apparatus for storing and organizing digital receipts. The apparatus may comprise one or more transceivers, one or more processors, and an output device. The transceivers are configured for receiving transaction information of two or more purchases completed by a shopper at different retail stores. The processors are configured to store the received transaction information of a transaction as digital receipt, organize two or more digital receipts according to date, time, retailer, location, etc., and retrieve a stored digital receipt in response to a user query. The output device is configured to display the retrieved digital receipt. In some embodiments, the digital receipts may be from different retail stores. Some purchases may be cash transaction or by gift cards.

In some embodiments, the system is integrated with the point-of-sale software of a retail store. The system may be installed in the retail store's IT system to collect and transmit transaction information of purchases completed by a shopper. The transaction information may comprise the date, the time, the retailer, the location of the retail store, a list of items in the transaction, the purchase price of each item on the list, and/or the total amount of the transaction. The system may comprise one or more transceivers and one or more processors. The transceivers are configured to receive and transmit data such as transaction information of a transaction completed by a shopper at a retail store. The processors are configured to identify a registered mobile device of the shopper for sending a text message to the registered mobile device. The text message may comprise the date, the time, the total amount of the transaction, and the name of the retail store. The transceivers are configured to send the text message to the registered mobile device and to transmit the transaction information to an application on a client machine designated by the shopper. In some embodiments, the client machine is the registered mobile device.

In some embodiments, the transaction information is transmitted via wireless transmission to the registered mobile device. For example, the transaction information is transmitted via a Near Field Communication Card or a Bluetooth device.

In some embodiments, the transaction information is stored on the registered mobile device as digital receipt. The digital receipts are organized for retrieval by date, retailer, or location.

The present disclosure also teaches a method of handling a digital receipt of a transaction completed by a shopper inside a retail store. The method may comprise the following steps. First, receive transaction information of the transaction from the point-of-sale system of the retail store. Second, identify a registered mobile device of the shopper; sending a text message to the registered mobile device. The text message may include the date, the time, the name of the retail store, and the total amount of the transaction. Third, transmit the transaction information to an application on a client machine designated by the shopper.

In some embodiments, the transaction information may comprise the date, the time, the retailer, the location of the retail store, a list of items in the transaction, the purchase price of each item on the list, and/or the total amount of the transaction. In some embodiments, the client machine is the registered mobile device, and the transaction information is transmitted via wireless transmission to the registered mobile device. In one embodiment, the transaction information is transmitted via a Near Field Communication Card or a Bluetooth device.

In some embodiments, the transaction information is stored on the registered mobile device as digital receipt. A plurality of digital receipts is stored and organized for retrieval by date, retailer, type of merchandise, or location.

### BRIEF DESCRIPTION OF THE DRAWINGS

These and other features of the present disclosure will become readily apparent upon further review of the following specification and drawings. In the drawings, like reference numerals designate corresponding parts throughout the views. Moreover, components in the drawings are not necessarily drawn to scale, the emphasis instead being placed upon clearly illustrating the principles of the present disclosure.

FIG. 1 is an illustration of a scenario in which transaction information of a purchase completed by a shopper is collected at a retail store.

FIG. 2 is a flowchart illustrating an exemplary procedure in which a shopper uses ReceetMe™ software to collect and transmit transaction information at a point of sales.

FIG. 3 is a flowchart illustrating an exemplary procedure of collecting and transmitting transaction information for aggregating and organizing by a user application.

FIG. 4 is an exemplary block diagram illustrating a system configured to collect and transmit transaction information for aggregation and organization by a user application.

FIG. 5 illustrates an exemplary procedure of aggregating and organizing digital receipts.

FIG. 6 illustrates an exemplary apparatus configured to aggregate and organize digital receipts.

FIG. 7-FIG. 12 are exemplary user interface of a ReceetMe′ mobile application illustrating transaction information or digital receipts being received, organized, retrieved and displayed.

### DETAILED DESCRIPTION

Embodiments of the disclosure are described more fully hereinafter with reference to the accompanying drawings, in which preferred embodiments of the disclosure are shown. The various embodiments of the disclosure may, however, be embodied in many different forms and should not be construed as limited to the embodiments set forth herein. Rather, these embodiments are provided so that this disclosure will be thorough and complete, and will fully convey the scope of the disclosure to those skilled in the art.

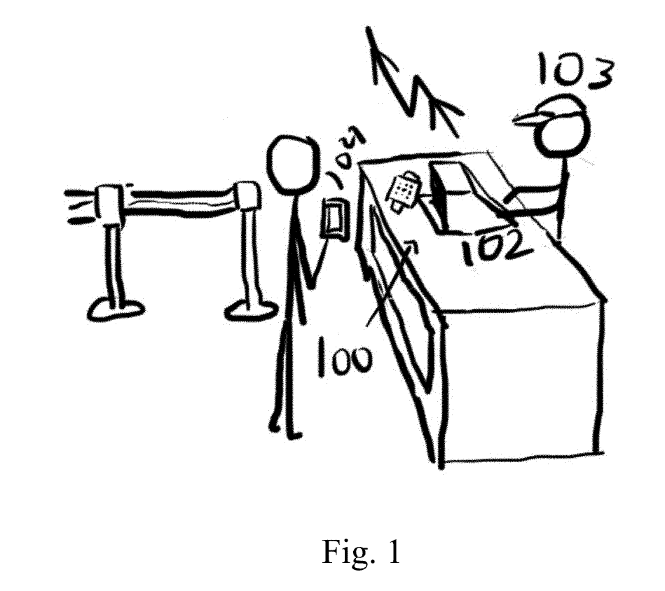

In referring to FIG. 1, a customer 101 checks out at a cashier counter 102. After the cashier 103 has rang up all purchase items, he takes the payment from the customer 101 and finishes the transaction. The payment may be made by credit card, debit card, gift card, check, or cash. In existing practice, the customer is prompted with a question of how she would like to receive the receipt, by email, print-out, or sometimes no receipt. If the customer chooses to receive the receipt via email, he will receive an email from the retail store. Receipts sent out by different stores are usually formatted differently. For example, an email receipt from Office Depot contains an JPG image of the paper receipt. Email receipts from other retail stores may be in digital format that include parsable data fields. But there is no uniform format that would allow digital receipts from different stores to be processed by a single application. The present disclosure teaches more convenient ways to collect and manage sales receipts.

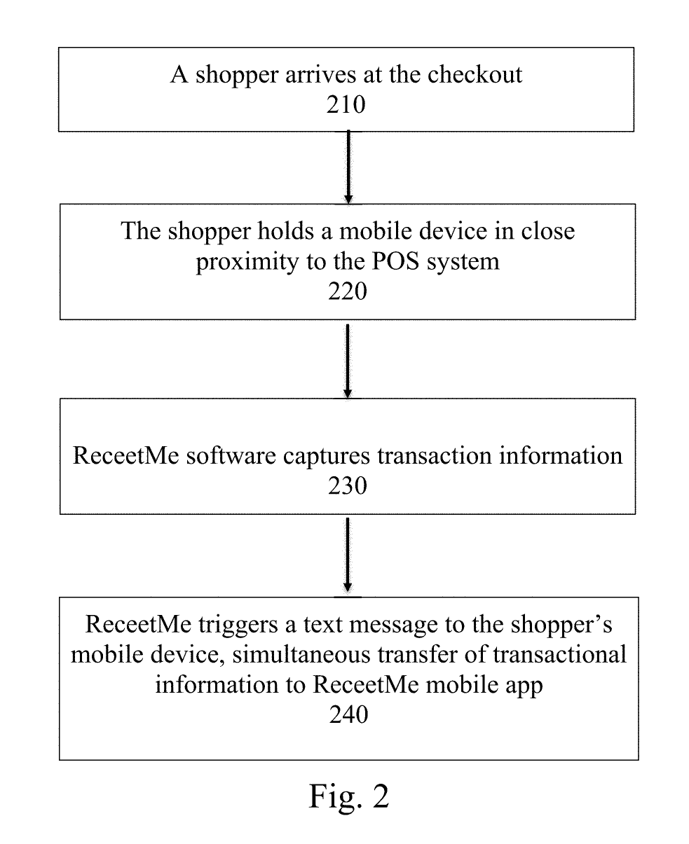

FIG. 1 illustrates an exemplary digital receipt system 100 for collecting and managing receipts. FIG. 2 illustrates how the exemplary digital receipt system 100 is utilized at the point of sales in a retail store. First, a customer 101 arrives at the checkout (step 210). After the cashier 103 has rang up all purchase items, the customer 101 holds a mobile device 104 in close proximity to the point-of-sale system installed at the cash register 102 (step 220). In one embodiment, the POS system is configured to send transaction information of each transaction to the exemplary system 100 for creating, collecting and managing receipts. In some embodiments, the exemplary system 100, e.g., ReceetMe™ software, captures the transaction information (step 230). The exemplary system 100 also triggers a text message to be sent to the customer's mobile device 104 to alert the customer, assuming that the mobile device 104 has been registered with the exemplary system 100 (step 240). The transaction information is also simultaneously sent to a receipt application (step 240). An example of the receipt application is the ReceetMe™ mobile app installed on the mobile device 104. Now that the transfer of the transaction information from the retail store's system to the exemplary system 100 is complete, the exemplary system 100 processes and stores the received transaction information as digital receipts.

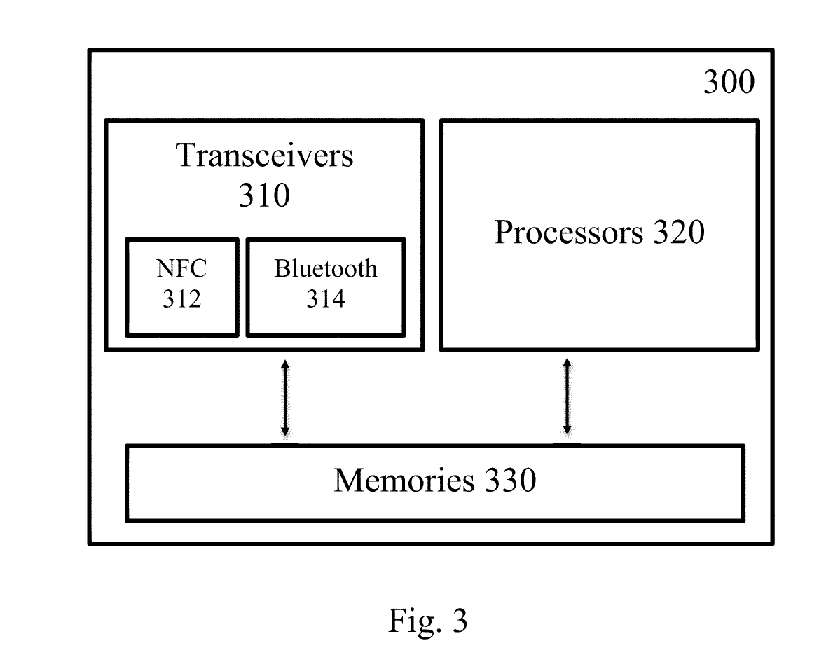

The exemplary digital receipt system 100 comprises at least two components. One component is installed in the retail store's IT system and is configured to communicate with the retail store's POS system. An example of this component is illustrated in FIG. 3 as the apparatus 300.

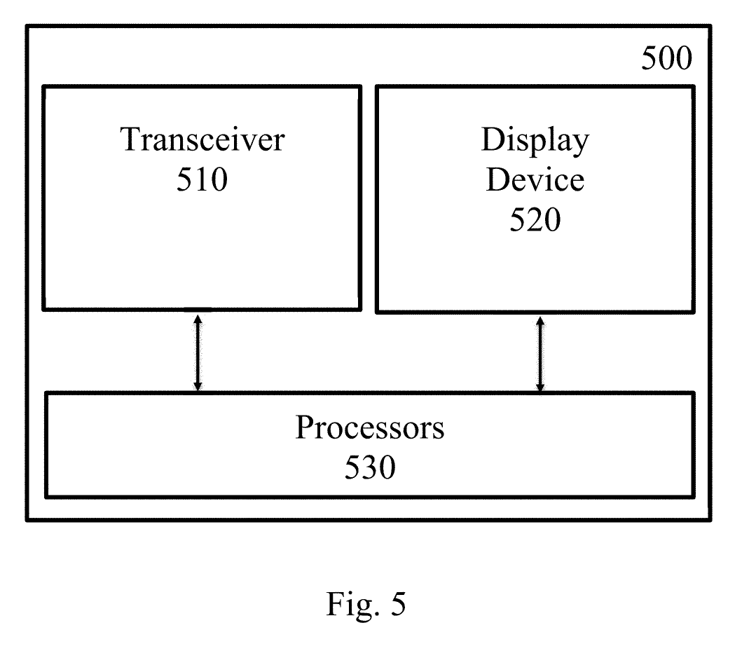

In referring to FIG. 3, the apparatus 300 comprises transceivers 310, processors 320, and memories 330. The transceivers 310 and the processors 320 are in data communication with the memories 330 via, for example, I/O buses. In some embodiments, the transceivers 310 may include a Near Field Communication (NFC) card 312 or a Bluetooth device 314. The transceivers are configured to receive, from the retail store's POS system, transaction information of a transaction completed by a shopper at the store. The memories 330 are configured to store the received transaction information and information about the shopper, for example, the registered mobile device or devices of the shopper. The processors 320 are configured to look up the registered mobile device or devices of the shopper and send a text message to the registered devices. In some embodiments, the text message includes the date, the time, the total amount of the transaction, and the name of the retail store. The processors 320 are also configured to identify a client machine designated by the shopper and send the transaction information to the client machine. In some embodiments, the client machine can be the same device as the registered mobile device 104. The transceivers 310 are configured to transmit the transaction information to an application on the designated client machine. It is noted that the apparatus 300 may belong to the retailer store but may be configured according to the teachings disclosed herein, for example, to communicate with the mobile device 104, or the apparatus 500 shown in FIG. 5.

In some embodiments, the apparatus 300 is configured to integrate with the retailer store's POS system. For example, Shopify, a POS company, has provided an open platform that allows software developers to develop apps on top of their system. Their open platform provides an open application programming interface (API), which after proper authentication, allows a software program to capture every transaction and the associated data. In some embodiments, ReceetMe™ software uses this API to capture transaction data for creating and publishing digital receipts.

The apparatus 300 shown in FIG. 3 may be further configured to communicate with the mobile device 104 or the apparatus 500 via wireless transmission. In some embodiments, the apparatus 300 may further include a NIC card or Bluetooth device to communicate with the mobile device 104 or the apparatus 500.

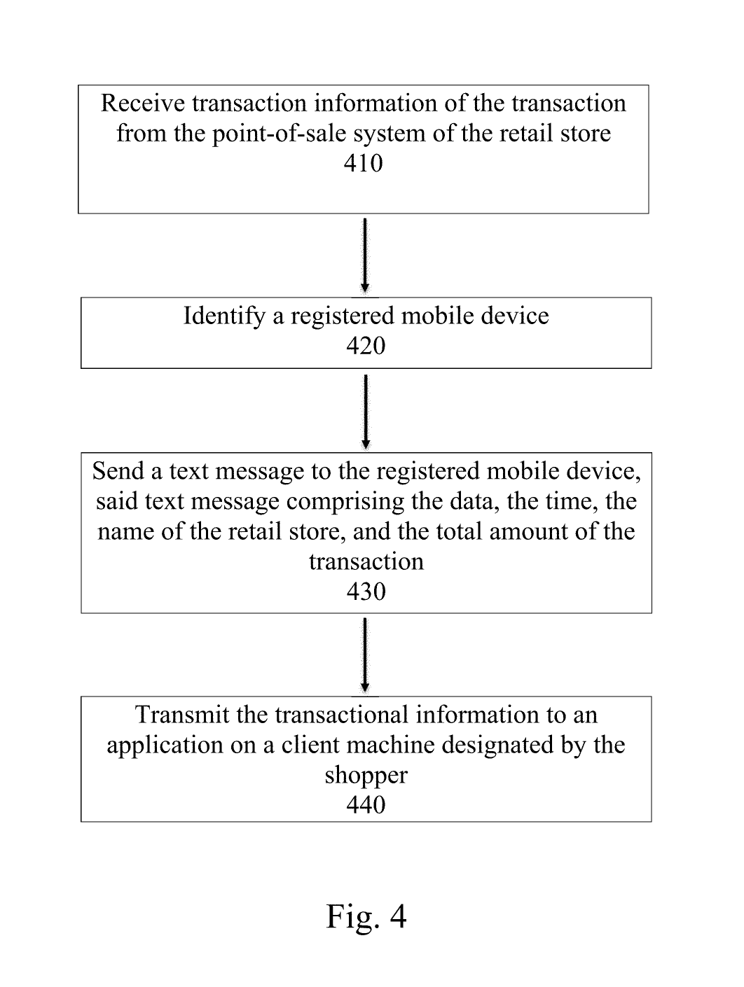

FIG. 4 illustrates the exemplary process 400 implemented on the apparatus 300. In the process 400, transaction information of the transaction is first received from the point-of-sale system of the retail store (step 410). Then a mobile device registered by the shopper with the exemplary system 100 is identified by the processors 320 (step 420). A text message including portions of the received transaction information is sent to the registered mobile device (step 430). Either subsequently or simultaneously, the received transaction information is transmitted to an application on the client machine designated by the shopper (step 430). An example of the application is the ReceetMe′ mobile app, and the application may be installed on another component of the exemplary digital receipt system 100, the apparatus 500 shown in FIG. 5.

The apparatus 500 comprises transceivers 510, display device 520, and processors 530. The transceivers 510 are configured to receive the transaction information of the transaction completed by the customer 101 at the retail store from the apparatus 300, which receives the transaction information from the retail store's POS system. The transaction information is received by the transceiver 510 as digital receipts.

The processors 530 are configured to store and manage digital receipts. These digital receipts may be from different retailers or at different retail stores. These digital receipts may be receipts of cash transaction. The processors 530 organize the digital receipts according to date, time, retailer, location, etc. The processors 530 are also configured to retrieve a stored digital receipt in response to a user query.

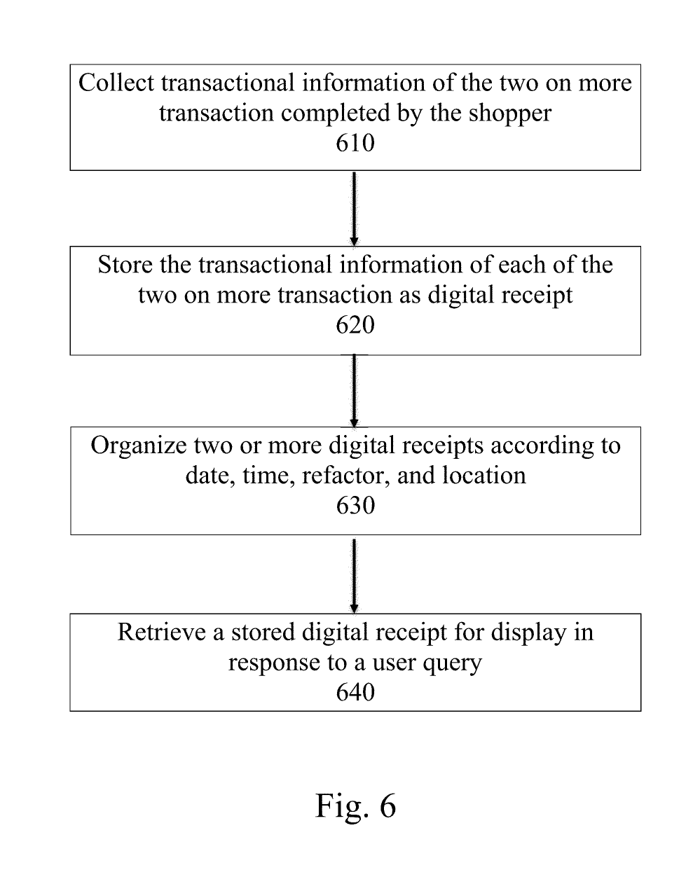

FIG. 6 illustrates the exemplary process implemented on the apparatus 500. In step 610, transaction information of multiple purchases is collected on the apparatus 500. The collected transaction information is then stored as digital receipts in step 620. A plurality of digital receipts is organized according to date, time, retailer, and/or location for easy retrieval in step 630. When a user needs to find a particular receipt, he can search the stored digital receipts based on date, time, retailer, and/or location. In step 640, the particular receipt the user is looking for is retrieved and presented on the display device 520 in response to a query he enters.

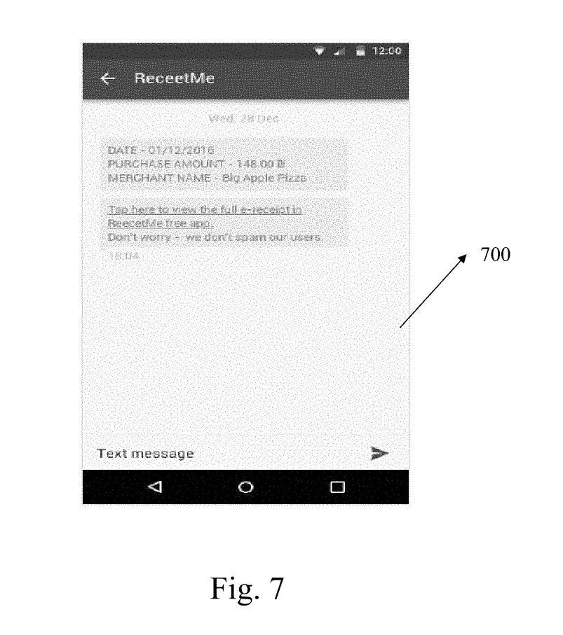

FIG. 7-FIG. 12 illustrates an exemplary embodiment of the application installed on a client machine, e.g., the registered mobile device 104 of the customer 101. In this embodiment, the application is named ReceetMe′. FIGS. 7-12 show various user interfaces designed to facilitate a user to manage, organize, search and retrieve digital receipts.

In FIG. 7, the registered mobile device 104 receives a text message from the apparatus 300. The text message is displayed on the user interface 700 of the mobile device 104. The user interface 700 resembles a smartphone screen. The text message lists the date (Jan. 12, 2016), the purchase amount ($148.00) and the merchant name (Big Apple Pizza) of the transaction. Underneath the text message, a link is provided for the user to tap and view the full receipt in the ReceetMe™ app.

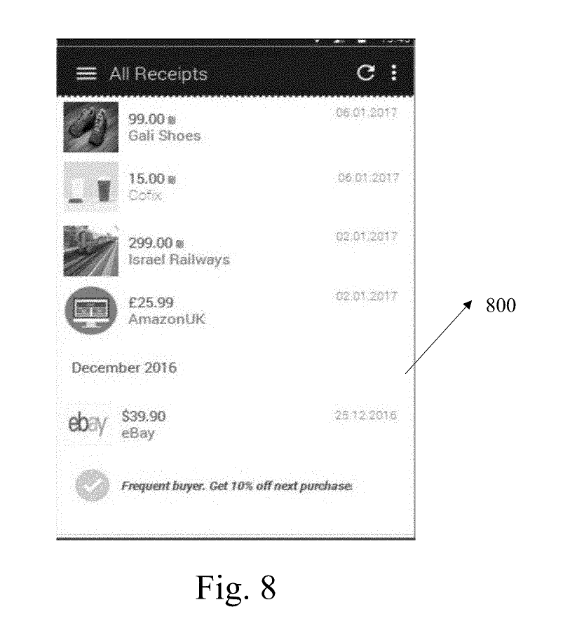

In FIG. 8, a user interface 800 of the ReceetMe™ app is illustrated. The user interface 800 presents a list of receipts displayed in a reverse chronological order. The header in the user interface 800 indicates that all receipts are displayed. The most recent transaction took place on Jun. 1, 2017 at Gali Shoes and the customer 101 bought a pair of shoes for $99.0. Another transaction also took place on Jun. 1, 2018 at a coffee shop called Cofix. The customer 101 bought coffee drinks for $15.0. The third transaction took place on Feb. 1, 2017, and it was a purchase of a train ticket at Israel Railways for $299.0. The fourth transaction is an Internet purchase from Amazon UK for £25.99. The purchase was also made on Feb. 1, 2017. The oldest purchase was made on Dec. 12, 2016 at eBay for $39.90. In this user interface 800, the items purchased in each transaction are not displayed.

In some embodiments, the list of receipts can be grouped and labeled for easy viewing. For example, in the user interface 800, the transaction(s) in 2016 is separated from those in 2017. A label of, e.g., the year and/or month, is used to mark the transition from one group of purchases into another. In some embodiments, an advertisement for a retailer may be displayed below the transaction the shopper completed with the retailer. For example, in the user interface 800, an advertisement “Frequent Buyer Get 10$ Off Next Purchase” is displayed below the eBay transaction. The advertisement can be sponsored by eBay or offered for free by ReceetMe™.

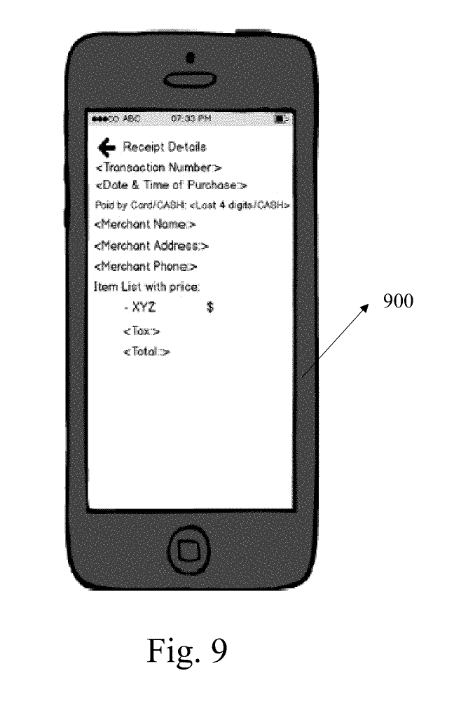

If the customer 101 wants to view the details of any receipt listed in the user interface 800, she can click or touch screen on a particular receipt. Another user interface 900 will open up. In the user interface 900 shown in FIG. 9, more details of that receipt are displayed. For instance, the transaction number and the date & time of the purchase are displayed. Whether the transaction was conducted using credit card or cash is also indicated. If it is paid using a credit card, the last four digits of the card number is listed. Additionally, the merchant name, address, and phone number may be listed. In this embodiment, the item list along with the price of each item on the listed are presented as well, along with the added tax and the total amount.

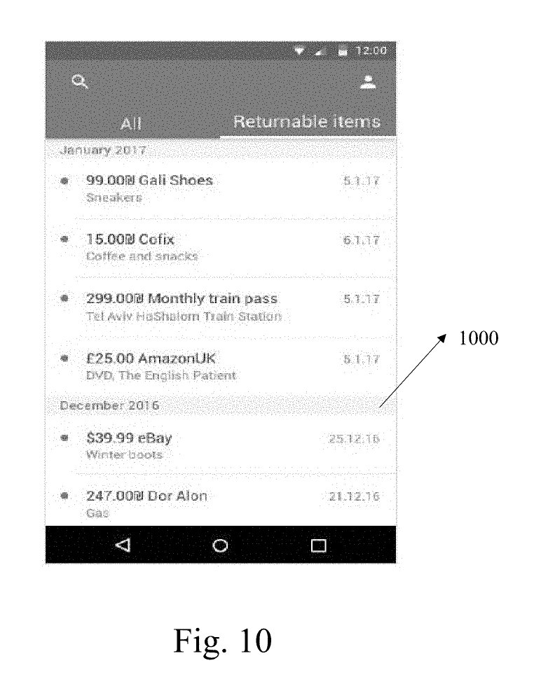

The digital receipt system 100 is helpful when the customer 101 needs to return a pair of shoes she recently bought. The biggest problem with paper receipts is that they get easily misplaced or lost. There is not such an issue with the digital receipt system 100. Receipts of all purchases are received and stored and can be easily retrieved when needed. In this example, the shopper needs to find the receipt that includes the sales of the pair of shoes she wants to return. In the user interface 1000 in FIG. 10, all returnable items are listed. For example, four purchases made in January 2017 include returnable items. They are the sneakers bought at Gali Stores, the coffee and snacks bought at the coffee shop called Cofix, the monthly train pass purchased at Tel Aviv Hashalem Train Station, and the English Patient DVD bought at Amazon UK. In December 2016, a couple of returnable items are listed as well.

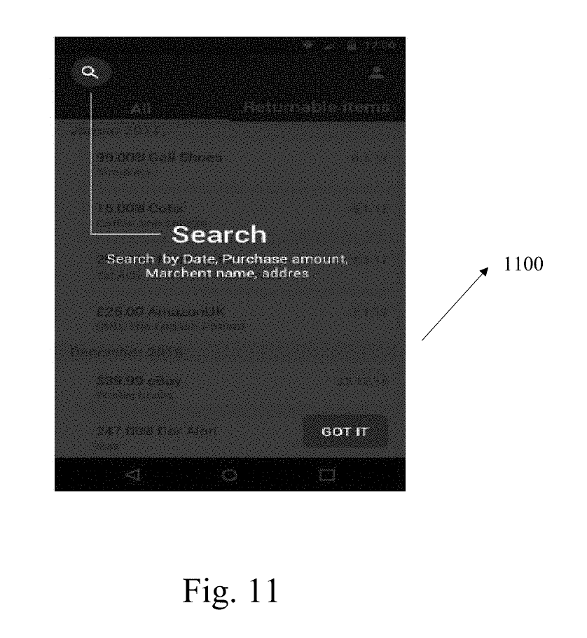

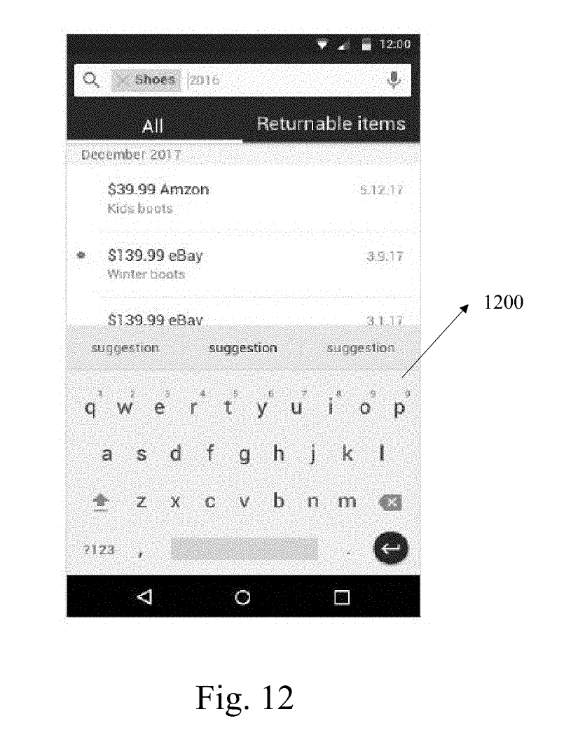

Because the items listed in the user interface 1000 do not have the pair of shoes, instead of scrolling down to the next screen, the shopper wants to search for the shoe receipt. She clicks on the search icon as shown in FIG. 11. The search icon is displayed on the top left corner of the user interface 1100. In FIG. 11, the customer 101 is reminded that the search function includes search by date, purchase amount, merchant name, address, etc. In some embodiments, the search function also allows the customer 101 to search for a specific type of merchandise, for example, shoes. The shopper clicks on the search icon and a text field appears along with a keyboard at the bottom of the screen. See FIG. 12. The customer 101 enters “shoes” and the year of “2017” in the search text field. A few items appear on the user interface 1200. On May 12, 2017, the shopper bought a pair of kid boots at Amazon for $39.99. The shopper also bought a pair of winter boots from eBay for $139.99 on Mar. 9, 2017. The winter boots are what the shopper wants to return. She now finds the receipt she is looking for.

The digital receipt system 100 allows users to get rid of paper receipts. The system 100 provides an easy, convenient, and reliable way for collecting, managing, organizing and searching digital receipts.

Although the disclosure is illustrated and described herein with reference to specific embodiments, the disclosure is not intended to be limited to the details shown. Rather, various modifications may be made in the details within the scope and range of equivalents of the claims and without departing from the disclosure.

What is claimed is:

1. An apparatus for storing and organizing digital receipts, comprising:
one or more transceivers for receiving transaction information of two or more purchases completed by a shopper at different retail stores;
one or more processors configured to:
store the received transaction information of each of the two or more purchases as digital receipt;
organize two or more digital receipts according to date, time, retailer, or location; and
retrieve a stored digital receipt in response to a user query; and
an output device for displaying the retrieved digital receipt.

2. The apparatus of claim 1, wherein the two or more digital receipts are from different retail stores.

3. The apparatus of claim 1, wherein one of the two or more purchases is a cash transaction.

4. The apparatus of claim 1, wherein the two or more digital receipts are stored and organized for retrieval by date, retailer, or location.

5. The apparatus of claim 1, wherein a list of digital receipts is retrieved for display on the output device and wherein the digital receipts are grouped into smaller groups according to the date or time for easy identification.

6. A method of storing and organizing digital receipts, comprising:
collecting transaction information of two or more purchases completed by a customer;
storing the transaction information of each of the two or more purchases as digital receipt;
organizing two or more digital receipts according to date, time, retailer, or location; and
retrieving a stored digital receipt for display in response to a user query.

7. The method of claim 6, wherein the two or more purchases are completed in at least two different retail stores.

8. The method of claim 6, wherein one of the two or more purchases is a cash transaction.

9. The method of claim 6, wherein the two or more digital receipts are stored and organized for retrieval by date, retailer, or location.

10. The method of claim 6, wherein a list of digital receipts is retrieved for display on the output device and wherein the digital receipts are grouped into smaller groups according to the date or time for easy identification.

11. A system for handling a digital receipt of a transaction completed by a customer inside a retail store, comprising:
one or more transceiver for receiving and transmitting data, wherein said one or more transceivers are configured to receive transaction information of a transaction completed by a shopper at a retail store from the point-of-sale system of the retail store;
one or more memories configured to store the received transaction information and information about the shopper; and
one or more processors configured to identify a registered mobile device of the shopper for sending a text message to the registered mobile device, wherein the text message comprises the date, the time, the total amount of the transaction or the name of the retail store;
wherein said transceivers are configured to send the text message to the registered mobile device and to transmit the transaction information to an application on a client machine designated by the shopper.

12. The system of claim 11, wherein the transaction information comprises the date, the time, the retailer, the location of the retail store, a list of items in the transaction, the purchase price of each item on the list, or the total amount of the transaction.

13. The system of claim 11, wherein the client machine is the registered mobile device.

14. The system of claim 13, wherein the transaction information is transmitted via wireless transmission to the registered mobile device.

15. The system of claim 14, wherein the transaction information is transmitted via a Near Field Communication card or a Bluetooth device.

16. A method of handling a digital receipt of a transaction completed by a customer inside a retail store, comprising:
receiving transaction information of the transaction from the point-of-sale system of the retail store;
identifying a registered mobile device of the shopper;
sending a text message to the registered mobile device, said text message comprising the date, the time, the name of the retail store, or the total amount of the transaction; and
transmitting the transaction information to an application on a client machine designated by the shopper.

17. The method of claim 16, wherein the transaction information comprises the date, the time, the retailer, the location of the retail store, a list of items in the transaction, the purchase price of each item on the list, or the total amount of the transaction.

18. The method of claim 16, wherein the client machine is the registered mobile device.

19. The method of claim 18, wherein the transaction information is transmitted via wireless transmission to the registered mobile device.

20. The method of claim 19, wherein the transaction information is transmitted via a Near Field Communication card or a Bluetooth device.
